(19) United States
(12) Patent Application Publication
(10) Pub. No.: US 2008/0181385 A1
(43) Pub. Date: Jul. 31, 2008

(54) Apparatus and System for Converting Public Switch Telephone Network to Wireless Personal Area Network

(76) Inventor: Ronald Eveland, Milwaukee, WI (US)

Correspondence Address: BOYLE FREDRICKSON S.C., 840 North Plankinton Avenue, MILWAUKEE, WI, 53203, US

(21) Appl. No.: 12/023,439

(22) Filed: Jan. 31, 2008

Related U.S. Application Data
(60) Provisional application No. 60/898,522, filed on Jan. 31, 2007.

(51) Int. Cl. H04M 7/00

(52) U.S. Cl. 379/219

(57) ABSTRACT

The present invention is a wireless personal area network created utilizing the pre-existing wiring from conventional payphone devices. A data aggregator is operably connected to the wiring for the payphones to connect the aggregator to a public switch telephone network (PSTN) so that the data aggregator can communicate with a data concentrator via the PSTN. The data concentrator periodically retrieves and forwards data from the Internet to the data aggregator along the PSTN at speeds much greater than that of a conventional Internet connection. The data aggregator stores this data for subsequent transmission to a personal data access device via a wireless network access device operably connected to the data aggregator. In this manner the personal device can access data at speeds greater than conventional direct Internet connections without ever directly connecting to the Internet.

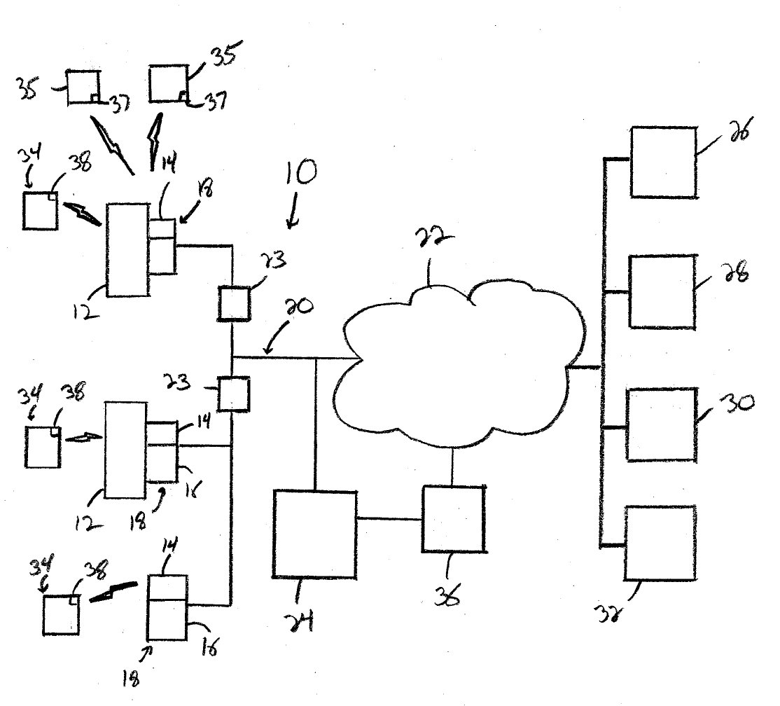

### CROSS-REFERENCE TO RELATED APPLICATIONS

This application claims priority from U.S. Provisional Patent Application Ser. No. 60/898,522, filed Jan. 31, 2007, the entirety of which is expressly incorporated by reference.

### FIELD OF THE INVENTION

The present invention relates to wireless networks, and more specifically to a wireless network constructed utilizing existing hardwired devices connected to or replaced by data retrieval devices that retrieve data from he Internet via the pre-existing phone lines and that can be wirelessly accessed by an individual to access information stored on the data retrieval devices without connection to the Internet through the data retrieval devices.

### BACKGROUND OF THE INVENTION

With the advent of wireless communication systems and devices, the need for and utility of existing hardwired payphone systems is greatly reduced. As a result, a large number of payphones are being removed, along with their accompanying wiring, due to the lack of use of these devices.

However, commensurate with the growth of wireless technologies, the need for being able to transmit clear wireless signals to be able to access or communicate with remote devices is also an issue. In order to at least partially alleviate the problems associated with the increase in demand on available wireless nodes, e.g., Wi-Fi hotspots, through which wireless signals from remote devices can be transmitted by individuals, many businesses are incorporating wireless nodes to enable individuals, such as employees and/or customers to more easily utilize wireless devices within their businesses.

However, to install these wireless nodes, additional hardwired connections must be made from the nodes to existing hardware in order for individuals utilizing the wireless nodes installed in this manner to communicate with other remote devices. Therefore, it is desirable to develop a system which can utilize existing hardwired connections in order to provide a multitude of readily available wireless communication nodes capable of routing wireless communications to desired locations.

Certain prior art systems have already been developed that utilize the wiring of the existing payphones to directly access other remote communication or information storage devices. For example, Petite et al., U.S. Pat. No. 7,079,810 discloses a method for communicating with a remote communications unit using a public switched telephone network (PSTN). In this system, an existing payphone device is either reconfigured with a radio frequency (RF) transceiver that can receive signals from a personal wireless device, such as a cell phone, personal digital assistant, or laptop computer, or the payphone device is completely removed and replaced by a wireless node that is connected to the existing wiring previously connected to the payphone device.

In the embodiment where the payphone device is present, the RF transceiver can receive signals from the personal wireless device and transmit those signals over the existing phone wiring. The signals from the personal wireless device can be routed by the RF transceiver through the Internet, when the individual utilizing the wireless device wishes to access information available on or through the Internet, or through the PSTN to another phone or computer that is connected to the PSTN, such as when making a phone call utilizing the personal wireless device. When the signal from the personal wireless device is transmitted through the payphone to the PSTN or Internet, the payphone device also blocks access to the phone line from the payphone receiver to avoid interruption of the connection between the personal wireless device and the separate device via the PSTN and/or the Internet.

In the embodiment where the node is present rather than the payphone device, the node takes the form of a modem or other suitable device incorporating the RF transceiver that is connected directly to the PSTN utilizing the pre-existing payphone wiring. Thus, the modem also enables the personal wireless device to connect directly to the Internet and/or to a separate device connected to the PSTN. However, due to the availability of the node to multiple personal wireless devices, it is possible that more than one device can simultaneously connect to the modem and access the Internet/PSTN at any one time, so long as the node has available bandwidth for the personal wireless device to access

However, while prior art systems have been developed that utilize the pre-existing wiring of payphone to provide wireless communications between a personal wireless device and a remote communications device via the PSTN and/or the Internet, for those communications made utilizing the Internet, there are certain drawbacks present in these existing systems. For example, in the system illustrated above in the '810 patent, the ability of a person to utilize the system to access the Internet is severely limited by the speed of the RF transceiver, modem, which based in its use on a telephone line is a dial-up or DSL modem, and/or the PSTN connection to the Internet. As such, the ability of the personal access device to access the Internet is necessarily much slower that is often required for the connection to be usable in an effective and efficient manner.

Further, due to restricted bandwidth of any Internet connection made through the payphone devices, which are normally broadband connections, there often can only be one connection made at any time, especially where the payphone is maintained in operation. This is because, should more than one connection be made to the PSTN or Internet in this system, the limited bandwidth capabilities will prevent any real time communications from being made through the system. As a result, the system described in the '810 patent is limited to a single user per payphone or node based on the connection speeds available.

Therefore, it is desirable to develop a communication system that allows for pre-existing payphone wiring to be utilized by multiple simultaneous users to access information retrieved from the Internet at speeds much greater than that achievable by a dial-up, broadband or DSL modem.

### SUMMARY OF THE INVENTION

According to one aspect of the present invention, existing payphones located in various urban and rural areas are configured into wireless communication devices, such as those capable of receiving ZigBee, Wi-Fi or Wi-MAX signals. The payphones are replaced or reconfigured to function as a data aggregator, meaning that the payphone or replacement device serves as an information storage and transmission device. The data aggregator is connected to the PSTN by the hardwired connections existing in the payphones that are operably connected to various PSTN lines to receive signals along these lines from a data concentrator. The data concentrator is configured to connect to and retrieve information via the Internet from a selected variety of different sources, i.e., from various information servers/websites also connected to the Internet. The data concentrator then forwards a block or blocks of information, e.g., such as all the information retrieved during the last one hour period, to the data aggregator via the PSTN. Then, via an RF transceiver operably connected to the data aggregator, the data aggregator then enables various portable personal wireless devices to access the data stored on the aggregator, without providing any direct connection to the Internet via the PSTN. By streamlining, and thereby speeding up, the process of getting the information to the data aggregator from the data concentrator, and eliminating direct access to the Internet and the PSTN by the personal wireless devices, the system of the present invention enables multiple personal wireless devices to simultaneously gain access to information from the Internet much faster than in a conventional wireless system where the user directly access the Internet, including a system that incorporates pre-existing wiring previously utilized for pay phones.

Numerous other aspects, features and advantages of the present invention will be made apparent from the following detailed description taken together with the drawing FIGURE.

### BRIEF DESCRIPTION OF THE DRAWINGS

The drawing figures illustrate the best mode currently contemplated of practicing the present invention.

In the drawings:

The drawing FIGURE is a schematic view of the wireless information network system of the present invention incorporating the data aggregator connected to the pre-existing pay phone wiring for connection to the data concentrator via the PSTN.

### DETAILED DESCRIPTION OF THE INVENTION

With reference now to the drawing FIGURE in which like reference numerals designate like parts throughout the disclosure, the system 10 constructed according to the present invention includes a number of conventional payphones 12. The payphones 12 are converted into wireless communication devices such as by replacing the payphones 12 with, or integrating within or on the payphones 12 a suitable wireless network access device 14, such as a Network Storage Device sold by D-Link® of Fountain Valley, Calif., and a data storage component 16, such as the ST 3400 network attached storage sold by Seagate Technology of Sunnyvale, Calif. In a preferred embodiment, the wireless network access device 14 and data storage component 16 are combined with other data processing components into the form of a data aggregator 18 that can be connected to the PSTN 20, and through the PSTN 20 to the worldwide web or Internet 22, or to other communication networks, by the existing twisted pair wiring of the PSTN 20 that can also optionally be connected to fiber optic network via switches, routers, multi-layer switches or publicly-switched devices (not shown). This is accomplished by replacing the existing hardware control with one or more (X) DSL converting devices 23 where X is A, G, S or V, in conjunction with a conversion protocol or algorithm, as is well known to one of ordinary skill in the art, and a circuit modified wireless access point, such as the wireless network access device 14. The existing cable or wire connecting the payphones 12 to the PSTN 20, or private branch exchange (not shown) or other routing device enables data to be transmitted along the PSTN 20, which eliminates the need for installation and construction of suitable wiring in existing buildings or new constructions when new equipment is to be installed.

The data aggregator 18 is operably connected via the PSTN 20, and optionally via the Internet 22, to a data concentrator 24 that, in turn, is operably connected via the Internet 22 to various servers 26-30 that contain various information sought to be transferred to the data concentrator 24, and from the data concentrator 24 to the data aggregator 18. This data obtained from the serves 26-30 can be any of the various types of data available from various websites (not shown) present and accessible on the Internet 22 that represent various database and FTP servers on which the information accessible through the websites is stored. For example, information is gathered from remote sites such as www.newspaperdirect.com, www.sportal.com, www.netflix.com, www.whatever-sports.com, www.ebooks.com, and the like using MicroSoft Integration Services via FTP, HTTP, etc. links. Additionally, the data obtained by the data concentrator 24 can be data concerning any changes that have been or are to be made to ZigBee full function, or reduced function devices 35, as they are stored on an appropriate server 32 that deals with the operation and control of these ZigBee devices 35. Thus, the data retrieved from these types of databases and stored in the data concentrator 24 can be utilized to enable control and setpoints to various ZigBee enabled slave devices 35, such as lighting, thermal sensors, security monitoring devices, and heating control for any of commercial buildings, offices or residential homes via communication between the wireless network access device 14 of the aggregator 18 and an RF transceiver 37 or other suitable device in the ZigBee device 35.

However, regardless of the source of the data, this data is accessed, retrieved by and stored in the data concentrator 24 in real time. Preferably, the data concentrator 24 is configured to access and retrieve the data from the selected servers/websites 26-32 periodically, such as every hour, in order to provide relatively continuous updates for the data provided to the data aggregator 18.

The information obtained from these servers/websites 26-32 is retrieved by the data aggregator 18 through the connection to the data concentrator 24 made by the PSTN 20 and the converting devices 23 for storage in the storage component 16 of the data aggregator 18. In one embodiment, the data concentrator 24 downloads the information obtained from the various websites onto the data aggregator 18 over a certain time period, such as hourly. In a preferred embodiment, multiple converting devices 23 are utilized on multiple connections or phone lines made between the data aggregator 18 and the data concentrator 24 via the PSTN 20. The multiple connections allow the data downloads into the data aggregator 18 to be initiated at different times to provide a more continuous update of the information on the data aggregator 18. For example, with four separate connections, the data aggregator 18 and/or data concentrator 24 can be configured to access or retrieve certain types of information at certain times, such as at staggered fifteen minute intervals. In this manner, the connections can be prevented from being completely utilized for data transfer between the data aggregator 18 and the data concentrator 24, thereby allowing for constant connectivity by multiple users, while also providing a consistent, but short delay in the real time nature of the data that is obtainable from the data aggregator 18.

Additionally, with these multiple connections, the data pulled from the Internet 22 and stored in the data concentrator 24 can also be directed or downloaded into the data aggregator 18 along the multiple connections in a faster manner than if accessed with a personal wireless device 34 via a standard Internet broadband connection. The ability to access and obtain the information from the data aggregator 18 using a personal wireless device 34 is also much faster than is possible utilizing a conventional Wi-Fi hotspot connection or other standard wireless network. More particularly, a typical broadband connection used in creating a Wi-Fi or other wireless network is 1.5 Meg to 5.0 Meg depending on type. However, the output of the wireless network access device 14 can send information at 54 M/bits per second, or about ten times quicker than a conventional Internet connection. Further, with the advent of 60 GHz and millimeter wave wireless network access devices 14, these devices are 400-500 times faster than a broadband Internet connection, with a download speed of about 2.2 Giga/bits per second. This would allow downloads of high volumes of data content from the data aggregator 18 to the personal wireless device 34 within seconds, as opposed to many minutes over a conventional broadband Internet connection.

The system 10 also includes a capability for the system 10 to control access to the data stored on the data aggregator 18. In those situations where the system 10 is not used in a free access environment, a user profile/information server 36 can be connected to the Internet 22 or to the data concentrator 24 for access by the data aggregator 18 in order to enable a user to identify their profile to be granted access to the data stored on the data aggregator 18. Once a user activates a suitable personal wireless device 34 within the broadcast range of the wireless network access device 14, the user can enter any suitable identifiers, passwords, usernames, combinations thereof, etc. that are stored on the server 36 in the profile for that user. Once received from the user via the personal wireless device 34, the data aggregator 18 retrieves/accesses the user's profile on the server 36 to verify the input information in order to either allow or deny access to the data storage component 16 by the user.

In addition to enabling access to the data stored on the data aggregator 18, the user profile information can be used to provide a method of payment in the operation of the system 10. For example, one the data aggregator 18 has accessed and verified the user information, the data aggregator 18 can note the access made by the user, e.g., by recording the time the user is connected to the system 10, or simply by noting the number of times that the user has connected to the system 10. In making this notation, the data aggregator 18 can also create a charge record for the access to the system 10 made by the user, such that an account for the user stored on the user's profile on server 36 can be debited an amount corresponding to the charge for the access to the system 10. The currency employed in the user's account for paying for the access to the system 10 can be any suitable currency used for this purpose, e.g., a bank account, but is more preferably selected from a non-monetary currency, such as frequent flyer miles on one or more different airlines.

To use the system 10, once a user having a suitable mobile, personal wireless device 34, such as an iPod, a personal digital assistant, a laptop computer or other suitable device, has come within the broadcast range of the one or more wireless network access devices 14 in the system 10, the user activates the device 34 and receives a signal via an RF transceiver 38 in the device 34 from the wireless network access devices 14 that the system 10 is present and available. This SSID signal or signals identifies the system 10 as well one of the various content providers to the system 10. The particular SSID broadcast by the system 10 can be modified as necessary on the data concentrator 24, especially to identify those servers/websites 26 having content available through the system 10 so that the user can identify and select the particular SSID corresponding to the information sought to be retrieved from the data aggregator 18.

At that point, the user then transmits using the transceiver 38 in the device 34 the proper information identifying the user from information stored on the server 36, which is received by the devices 14 and verified by the data aggregator 18. Once verified, the user is able to access all of the data currently stored or being downloaded onto the data aggregator 18 from the data concentrator 24 under the selected SSID using the wireless RF connection between the network access device 14 and the transceiver 38 in the personal wireless device 34. However, the user is not provided with any direct access through the data aggregator 18 to the PSTN 20 or the Internet 22. Only that information that is present in the data storage portion 16 of the data aggregator 18 is able to be accessed by the device 34 of the user. Utilizing the multiple connections between the data concentrator 24 and the servers 26-32 over the Internet 22, and the connections between the data aggregator 18 and the data concentrator 24 over the PSTN 20, the data stored in the data storage component 16 of the data aggregator 18 that is accessible to the user is continuously updated, providing the user with data having a delay associated with the time required to have the data retrieved from the server 26-32 or website by the data concentrator 24, and to have the data downloaded into the storage component 16 of the data aggregator 18. However, at the data transfer speeds capable in the system 10 of the present invention, this delay is minimal, such that the user receives access to virtually real-time data through the system 10.

The system 10 of the present invention is primarily designed for use in commercial or public locations, such as within airports, office building, shopping malls, and retail establishments, among others. Additionally, while the above described preferred embodiments of the system 10 cover a single data aggregator 18 in conjunction with a single data concentrator 24, it is also contemplated that the system 10 can employ multiple aggregators 18 and concentrator 24 to increase the amount of available information for access by a user.

Various alternatives are contemplated as being within the scope of the following claims particularly pointing out and distinctly claiming the subject matter regarded as the invention.

What is claimed is:

1. A wireless personal area network comprising:
a) at least one data aggregator device operably connected to a public switch telephone network (PSTN) utilizing pre-existing pay-type telephone hardwired connections, the at least one data aggregator device including a first data transceiver device and a first data storage device;
b) at least one data concentrator operably connected to a data communications link and to the PSTN and having a second data storage device, the data concentrator configured to access, retrieve and store information from various data servers over the data communications link in the second data storage device, and to transmit the information from the second data storage device to the first data storage device of the at least one data aggregator; and
c) at least one personal wireless data access device including a second transceiver device configured to communicate with the first transceiver device of the at least one data aggregator to access and retrieve data from the first data storage device of the at least one data aggregator, and wherein the at least one data aggregator is configured to prevent communications from the at least one personal wireless data access device from accessing the PSTN or the data communications link through the at least one data aggregator.

2. The wireless personal area network of claim 1 wherein the at least one data concentrator is configured to periodically access, retrieve and store information from the various servers.

3. The wireless personal area network of claim 1 wherein the at least one data concentrator is configured to periodically download information stored in the second data storage device to the first data storage device of the at least one data aggregator.

4. The wireless personal area network of claim 3 wherein the at least one data concentrator is configured to periodically download equal portions of the information stored in the second data storage device to the first data storage device in the at least one aggregator.

5. The wireless personal area network of claim 1 further comprising a user information database operably connected to the at least one data aggregator over the PSTN and including a user information database accessible by the at least one data aggregator.

6. The wireless personal area network of claim 1 further comprising a third data transceiver device operably connected to the at least one data aggregator and configured to communicate with the second data transceiver device of the at least one personal data access device.

7. The wireless personal area network of claim 1 further comprising:
a) a first personal data access device including the second data transceiver device; and
b) a second personal data access device including a fourth data transceiver device configured to communicate with the first transceiver device of the at least one data aggregator to access and retrieve data from the first data storage device of the at least one data aggregator, and wherein the at least one data aggregator is configured to prevent communications from the first and second personal wireless data access devices from accessing the PSTN or the data communications link through the at least one data aggregator.

8. The wireless personal area network of claim 1 further comprising at last one digital subscriber line (DSL) converting device operably connected to the PSTN between the at least one data concentrator and the at least one data aggregator.

9. A wireless personal area network comprising:
a) at least one data aggregator device operably connected to a public switch telephone network (PSTN) utilizing pre-existing pay-type telephone hardwired connections, the at least one data aggregator device including a first data transceiver device and a first data storage device;
b) at least one data concentrator operably connected to a data communications link and to the PSTN and having a second data storage device, the data concentrator configured to access, retrieve and store information from various data servers over the data communications link in the second data storage device, and to transmit the information from the second data storage device to the first data storage device of the at least one data aggregator; and
c) at least one personal wireless data access device including a second transceiver device configured to communicate with the first transceiver device of the at least one data aggregator to access and retrieve data from the first data storage device of the at least one data aggregator, wherein the at least one data aggregator is configured to prevent communications from the at least one personal wireless data access device from accessing the PSTN or the data communications link through the at least one data aggregator, wherein the at least one data concentrator is configured to periodically access, retrieve and store information from the various servers and wherein the at least one data concentrator is configured to periodically download information stored in the second data storage device to the first data storage device of the at least one data aggregator.

10. The wireless personal area network of claim 9 wherein the at least one data concentrator is configured to periodically download equal portions of the information stored in the second data storage device to the first data storage device in the at least one aggregator.

11. The wireless personal area network of claim 10 wherein the at least one data concentrator is configured to periodically download equal portions of the information stored in the second data storage device to the first data storage device in the at least one aggregator in staggered time intervals.

12. The wireless personal area network of claim 9 further comprising a user information database operably connected to the at least one data aggregator over the PSTN and including a user information database accessible by the at least one data aggregator.

13. The wireless personal area network of claim 9 further comprising a third data transceiver device operably connected to the at least one data aggregator and configured to communicate with the second data transceiver device of the at least one personal data access device.

14. The wireless personal area network of claim 9 further comprising:
a) a first personal data access device including the second data transceiver device; and
b) a second personal data access device including a fourth data transceiver device configured to communicate with the first transceiver device of the at least one data aggregator to access and retrieve data from the first data storage device of the at least one data aggregator, and wherein the at least one data aggregator is configured to prevent communications from the first and second personal wireless data access devices from accessing the PSTN or the data communications link through the at least one data aggregator.

15. The wireless personal area network of claim 9 further comprising a third data transceiver device operably connected to the at least one data aggregator and configured to communicate with the second data transceiver device of the at least one personal data access device.

16. A wireless personal area network comprising:
a) at least one data aggregator device operably connected to a public switch telephone network (PSTN) utilizing pre-existing pay-type telephone hardwired connections, the at least one data aggregator device including a first data transceiver device and a first data storage device;
b) at least one data concentrator operably connected to a data communications link and to the PSTN and having a second data storage device, the data concentrator configured to access, retrieve and store information from various data servers over the data communications link in the second data storage device, and to transmit the information from the second data storage device to the first data storage device of the at least one data aggregator; and
c) a first personal wireless data access device including a second transceiver device configured to communicate with the first transceiver device of the at least one data aggregator to access and retrieve data from the first data storage device of the at least one data aggregator; and
d) a second personal data access device including a fourth data transceiver device configured to communicate with the first transceiver device of the at least one data aggregator to access and retrieve data from the first data storage device of the at least one data aggregator, and wherein the at least one data aggregator is configured to prevent communications from the first and second personal wireless data access devices from accessing the PSTN or the data communications link through the at least one data aggregator.

17. The wireless personal area network of claim 16 wherein the at least one data concentrator is configured to periodically access, retrieve and store information from the various servers.

18. The wireless personal area network of claim 16 further comprising a user information database operably connected to the at least one data aggregator over the PSTN and including a user information database accessible by the at least one data aggregator.

19. The wireless personal area network of claim 16 further comprising a third data transceiver device operably connected to the at least one data aggregator and configured to communicate with the second data transceiver device of the at least one personal data access device.

20. The wireless personal area network of claim 1 further comprising a fifth data transceiver device disposed within a full function or limited function slave device adapted to control the operation of an electronic system separate from the network, the fifth data transceiver device configured to communicate with the first transceiver device of the at least one data aggregator to access and retrieve data from the first data storage device of the at least one data aggregator.
